(19) United States
(12) Patent Application Publication
(10) Pub. No.: US 2026/0095821 A1
(43) Pub. Date: Apr. 2, 2026

(54) METHODS, NETWORK FUNCTION NODES AND COMPUTER READABLE MEDIA FOR EVENT REPORT MANAGEMENT

(71) Applicant: Telefonaktiebolaget LM Ericsson (publ), Stockholm (SE)

(72) Inventors: Emiliano MERINO VAZQUEZ, Madrid (ES); Maria Cruz BARTOLOME RODRIGO, Madrid (ES); Yunjie LU, Shanghai (CN)

(21) Appl. No.: 19/110,160

(22) PCT Filed: Sep. 21, 2022
(86) PCT No.: PCT/CN2022/120149

§ 371 Date: Mar. 10, 2025

(51) Int. Cl. H04W 36/00

(52) U.S. Cl. CPC H04W 36/0058

(57) ABSTRACT

The present disclosure provides methods for managing an event report for a user equipment served by a first NF node. The method is implemented at the first NF node, and comprises in response to receiving, from a second NF node, a UE context transfer request when the UE moves to be served by the second NF node, including in first UE context an indication indicating an event status of the UE for a first subscribed event that is reported last, and transmitting the first UE context to the second NF node. The present disclosure further discloses corresponding NF nodes for implementing the method and corresponding computer readable medium.

### TECHNICAL FIELD

The present disclosure generally relates to the technical field of telecommunication, and particularly to methods and Network Function (NF) nodes for managing event reports for a User Equipment (UE) and corresponding computer readable medium.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

In Fifth Generation (5G) networks, a Network Slice is introduced as a logical network that provides specific network capabilities and network characteristics. An instance of a network slice (e.g. a network slice instance, NSI) is a set of NF instances and the required resources (e.g., computing, storage, and networking resources) which form a deployed Network Slice. An NF is a 3GPP adopted or 3GPP defined processing function in a network, which has defined functional behavior and 3GPP defined interfaces. An NF can be implemented either as a network element on dedicated hardware, a software instance running on a dedicated hardware, or as a virtualized functional instantiated on an appropriate platform, e.g., on a cloud infrastructure. An NF instance is an identifiable instance of the NF. An NF service is a functionality exposed by a NF through a service-based interface and consumed by other authorized NFs. An NF service instance is an identifiable instance of the NF service. An NF Service Set is a group of interchangeable NF service instances of the same service type within an NF instance. The NF service instances in the same NF Service Set have access to the same context data. An NF set is a group of interchangeable NF instances of the same type, supporting the same services and the same Network Slice(s). The NF instances in the same NF Set may be geographically distributed but have access to the same context data.

As specified in 3GPP TS 23.501, 5G System supports the functionality of tracking and reporting UE mobility events.

In particular, 3GPP TS 23.501 specifies the following:

The AMF provides the UE mobility related event reporting to NF that has been
authorized to subscribe to the UE mobility event reporting service. Any NF service
consumer such as SMF, NEF or NWDAF that wants to be reported on the UE
location is able to subscribe to the UE mobility event notification service to the AMF
with the following parameters:
Event reporting type that specifies what to be reported on UE mobility (e.g. UE
location, UE mobility on Area of Interest).
Event filters indicating the:
Area Of Interest that specifies a location area within 3GPP system. The
Area Of Interest is represented by a list of Tracking Areas, list of cells or list
of (R)AN node identifiers. In the case of LADN, the event consumer (e.g.
SMF) provides the LADN DNN to refer the LADN service area as the Area
Of Interest. In the case of PRA, the event consumer (e.g. SMF or PCF) may
provide an identifier for Area Of Interest to refer predefined area as the Area
Of Interest.
S-NSSAI and optionally the NSI ID(s).
Event Reporting Information: event reporting mode, number of reports,
maximum duration of reporting, event reporting condition (e.g. when the target
UE moved into a specified Area Of Interest, immediate reporting flag).
Notification Endpoint of NF service consumer to be notified.
The target of event reporting that indicates a specific UE, a group of UE(s) or
any UE (i.e. all UEs). Further details on the information provided by the NF
service consumer are provided in clause 4.15 of TS 23.502 [3].
If an NF service consumer subscribes to the UE mobility event notification service
provided by AMF for reporting of UE presence in Area Of Interest, the AMF tracks
UE's location considering UE's CM state and using NG-RAN procedures (if RRC
Inactive state applies to NG-RAN) in order to determine the UE presence in the
Area Of Interest, as described in clause 4.15.4.2 of TS 23.502 [3]. Upon detecting
the change of the UE presence in the Area Of Interest, the AMF notifies the UE
presence in the Area Of Interest and the new UE location to the subscribed NF
consumer.
When the AMF is changed, the subscription of mobility event is transferred from the
old AMF. The new AMF may decide not to notify the SMF with the current status
related to the subscription of mobility event if the new AMF determines that, based
on MM Context of the UE, the event is reported by the old AMF.
In the network deployment where a UE may leave or enter the Area Of Interest
without any notification to the 5GC in CM-CONNECTED state (i.e. in the case that
RRC Inactive state applies to the NG-RAN), the AMF may initiate the NG-RAN
location reporting as described in clause 5.4.7 or N2 Notification as described in
clause 4.8.3 of TS 23.502 [3] to track the UE presence in the Area Of Interest.

Within the 5G Core Network, 5GC, the Access and Mobility Management Function, AMF, offers services to Session Management Function, SMF, other AMF, Policy Control Function, PCF, Short Message Service Function, SMSF, Network Data Analytics Function, NWDAF, Network Exposure Function, NEF and other NFs via the Namf service based interface.

3GPP TS 29.518 specifies the services offered by the AMF, among which Namf_EventExposure Service is defined. The AMF may offer this service as a Service Producer to enable an NF to subscribe to event notifications on its own or on behalf of another NF and get notified about an event. The known Service Consumers are NEF, SMF, Unified Data Management, UDM, NWDAF, Data Collection Coordination Function, DCCF, Location Management Function, LMF, and Gateway Mobile Location Centre, GMLC. An event, Presence-In-AOI-Report, is provided by Namf_EventExposure Service.

In particular, regarding the event Presence-In-AOI-Report, 3GPP TS 29.518 5.3.1 specifies:

Event: Presence-In-AOI-Report
A NF subscribe to this event to receive the current present state of a UE or a
group of UEs or any UE in a specific Area of Interest (AOI), and notification when a
specified UE enters or leaves the specified area. The area could be identified by a
TA list, an area ID or specific interested area name like “LADN”.
UE Type: One UE, Group of UEs, any UE
Report Type: One-Time Report, Continuously Report
Input: UE ID(s), “ANY_UE”, Area identifier (a TA list, an area Id or
“LADN”), S-NSSAI, NSI ID.
Notification: UE-ID(s), Area identifier, Presence Status
(IN/OUT/UNKNOWN)

As defined in 3GPP TS 29.518, the AMF notifies the service subscriber when a specified UE enters or leaves the specified AOI area. When the UE moves from an old AMF and is served by a new AMF, the old AMF transfers the UE context to the new AMF, which includes the subscription of AOI event. The new AMF will notify the event subscriber with the status of the UE. However, if the status of the UE of the AOI event does not change during the UE movement, the event subscriber had already received the report of the status of the UE from the old AMF. The report of the status of the UE from the new AMF is redundant.

### SUMMARY

At least some objects of the present disclosure are to provide technical solutions capable of allowing the new AMF which receives UE context from an old AMF during an inter-AMF mobility procedure to be aware of the status of the UE that is last reported from the old AMF, and thereby avoiding transmitting redundant reports of the event.

According to a first aspect of the present disclosure, there is provided a method implemented at a first NF node for managing an event report for a UE that is served by the first NF node. The method comprises step of, in response to receiving, from a second NF node, a UE context transfer request when the UE moves to be served by the second NF node, including in first UE context an indication indicating an event status of the UE for a first subscribed event that is reported last, and transmitting the first UE context to the second NF node.

In an exemplary embodiment, the method may further comprise a step of, in response to receiving second UE context from a third NF node, the UE context including an indication indicating an event status of the UE for a second subscribed event that is reported last, determining whether the current event status of the UE of the second subscribed event has changed from the event status that is reported last by checking the indication in the second UE context.

In an exemplary embodiment, the method may further comprise a step of transmitting an event report indicating the current event status of the UE of the second subscribed event only if it is determined that the current event status of the UE of the second subscribed event has changed from the event status that is reported last.

In an exemplary embodiment, the subscribed event, i.e., each of the first and second subscribed events, is an AOI event.

In an exemplary embodiment, the method may further comprise a step of checking whether the first subscribed event is an ongoing event, and the step of including an indication in the first UE context may comprise including the indication in the first UE context if the first subscribed event is an ongoing event.

In an exemplary embodiment, ach of the first NF node, the second NF node and the third NF node is an AMF node. In other words, the method applies during an inter-AMF mobility procedure.

In an exemplary embodiment, prior to receiving a UE context transfer request, the method may further comprise a step of receiving a request from a fourth NF node to subscribe to the event for the UE. That is, the event is subscribed by the fourth NF node, a NF service consumer, and then the event report shall be correctly transmitted to the fourth NF node.

In an exemplary embodiment, a Report Type for the subscribed event, i.e., each of the first and second subscribed events, is Continuously Report.

In an exemplary embodiment, each of the first and second subscribed events is subscribed per UE, or per group of UEs.

In an exemplary embodiment, the event report indicates the presence status of the UE in the AOI, including IN/OUT/UNKNOWN.

According to a second aspect of the present disclosure, a first NF node is provided for managing an event report for a UE that is served by the first NF node, comprising: a communication interface arranged for communication, at least one processor, and a memory comprising instructions which, when executed by the at least one processor, cause the first NF node to perform the method of the first aspect said above.

According to a third aspect of the present disclosure, there is provided a computer program comprising instructions which, when executed by at least one processor, cause the first NF node to carry out the method of the first aspect said above.

According to a fourth aspect of the present disclosure, there is provided a carrier containing the computer program discussed above, wherein the carrier is one of an electronic signal, optical signal, radio signal, or computer readable storage medium.

According to the above technical solutions of the present disclosure, a source NF service provider (for example, the first NF node), which supports an event notification to a subscribed NF node, provides an indication indicating the last report event status of the UE for the subscribed event to a second source NF service provider (i.e., the second NF node) along with the subscription of the subscribed event in for example, the UE context, so that the second NF node may decide whether to report the current status of the subscribed event by checking the received indication. The second NF node thus will not report the status of the subscribed event that has been reported by the first NF node, reducing the redundant and wrong information, and reducing the possibility of wrongly decrementing the number of reports.

### BRIEF DESCRIPTION OF THE DRAWINGS

The objects, advantages and characteristics of the present disclosure will be more apparent, according to descriptions of preferred embodiments in connection with the drawings, on which:

FIG. 1 illustrates one example of a wireless communication system in which embodiments of the present disclosure may be implemented;

FIG. 2 illustrates a wireless communication system represented as a 5G network architecture composed of core NFs;

FIG. 3 illustrates a 5G network architecture using service-based interfaces between the NFs in the control plane, instead of the point-to-point reference points/interfaces used in the 5G network architecture of FIG. 2;

FIG. 4 illustrates a scenario of an inter-AMF mobility procedure, where each time UE moves from an AMF to be served by another AMF will trigger an AOI report;

FIG. 5A illustratively shows a flowchart of a method for managing an event report for a UE according to an exemplary embodiment of the present disclosure;

FIG. 5B illustratively shows a flowchart of another method for managing an event report for a UE according to an exemplary embodiment of the present disclosure;

FIG. 6 shows an exemplifying signaling diagram illustrating a scenario where the indication of the present disclosure is applied according to an exemplary embodiment of the present disclosure;

FIG. 7 illustratively shows a schematic structure diagram of a first NF node according to an exemplary embodiment of the present disclosure; and

FIG. 8 illustratively shows a schematic structure diagram of a first NF node according to an exemplary embodiment of the present disclosure.

It should be noted that throughout the drawings, same or similar reference numbers are used for indicating same or similar elements; various parts in the drawings are not drawn to scale, but only for an illustrative purpose, and thus should not be understood as any limitations and constraints on the scope of the present disclosure.

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in references as follows:
1) 3GPP TS 23.501, V17.5.0 (June 2022),
2) 3GPP TS 29.122 V17.5.0 (March 2022),
3) 3GPP TS 29.503 V17.6.0 (March 2022),
4) 3GPP TS 29.518 V17.6.0 (June 2022), and
5) 3GPP TS 29.522 V17.5.0 (March 2022).

References in this specification to “one embodiment,” “an embodiment,” “an example embodiment,” etc. indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of the skilled in the art to affect such feature, structure, or characteristic in connection with other embodiments whether or not explicitly described.

The terminology used herein is for the purpose of describing particular embodiments only and is not intended to be liming of exemplary embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

The techniques described herein may be used for various wireless communication networks such as Code Division Multiple Access (CDMA), Time Division Multiple Access (TDMA), Frequency Division Multiple Access (FDMA), Orthogonal Frequency Division Multiple Access (OFDMA), Single Carrier-Frequency Division Multiple Access (SC-FDMA), Long Term Evolution (LTE), New Radio (NR) and other networks developed in the future. The terms “network” and “system” are sometimes used interchangeably. For illustration only, certain aspects of the techniques are described below for the 5th generation of wireless communication network. However, it will be appreciated by the skilled in the art that the techniques described herein may also be used for other wireless networks such as LTE and corresponding radio technologies mentioned herein as well as wireless networks and radio technologies proposed in the future.

One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device.

As used herein, the term “UE” may be, by way of example and not limitation, a User Equipment (UE), a SS (Subscriber Station), a Portable Subscriber Station (PSS), a Mobile Station (MS), a Mobile Terminal (MT) or an Access Terminal (AT). The UE may include, but not limited to, mobile phones, cellular phones, smart phones, or personal digital assistants (PDAs), portable computers, image capture terminal devices such as digital cameras, gaming terminal devices, music storage and playback appliances, wearable terminal devices, vehicle-mounted wireless terminal devices and the like. In the following description, the terms “UE”, “wireless communication device,” “terminal device,” “mobile terminal” and “user equipment” may be used interchangeably.

As used herein, a “network node” is any node that is either part of the radio access network or the core network of a cellular communications network/system.

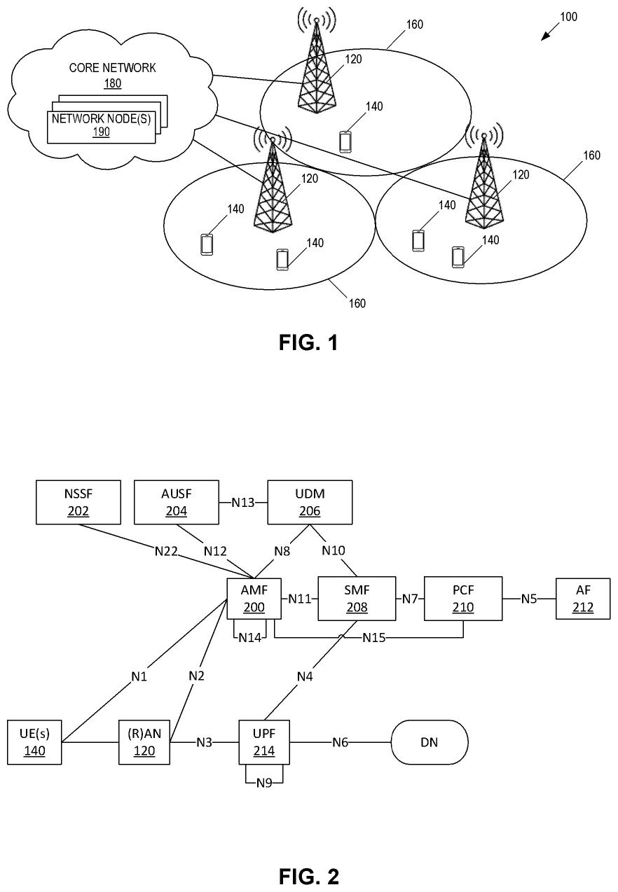

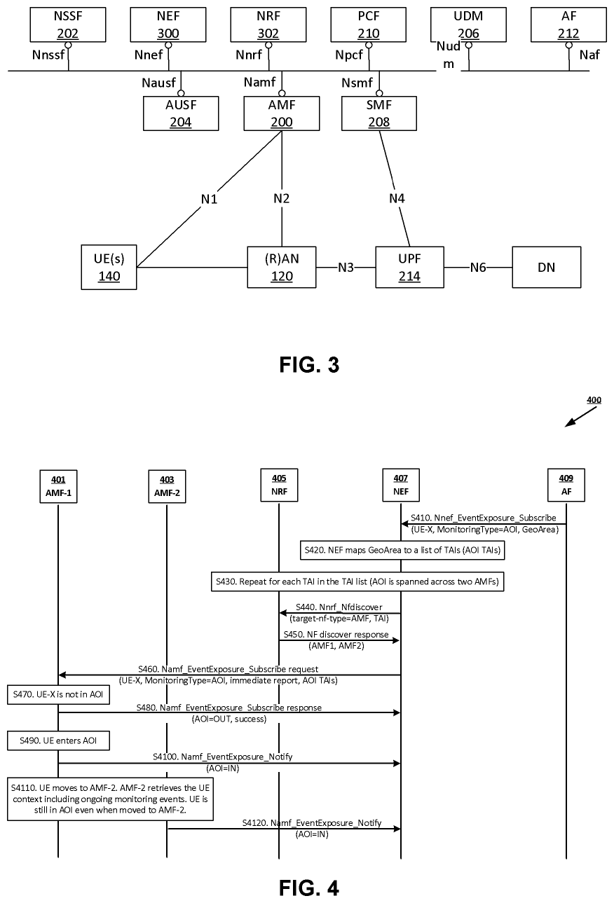

FIG. 1 illustrates one example of a wireless communication system 100 in which embodiments of the present disclosure may be implemented. The wireless communication system 100 may be a cellular communications system such as, for example, a 5G New Radio (NR) network or an LTE cellular communications system. As illustrated, in this example, the wireless communication system 100 includes a plurality of radio access nodes 120 (e.g., evolved Node B: s (eNBs), 5G base stations which are referred to as gNBs, or other base stations or similar) and a plurality of wireless communication devices 140 (e.g., conventional UEs, Machine Type Communication (MTC)/Machine-to-Machine (M2M) UEs). The wireless communication system 100 is organized into cells 160, which are connected to a core network 180 via the corresponding radio access nodes 120. The radio access nodes 120 are capable of communicating with the wireless communication devices 140 (also referred to herein as communication device 140 or UEs 140) along with any additional elements suitable to support communication between wireless communication devices or between a wireless communication device and another communication device (such as a landline telephone). The core network 180 includes one or more network node(s) or function(s) 190. In some embodiments, the network nodes/functions 190 may comprise, for example, any of the network functions shown in FIGS. 2-3.

FIG. 2 illustrates a wireless communication system represented as a 5G network architecture composed of core Network Functions (NFs), where interaction between any two NFs is represented by a point-to-point reference point/interface. FIG. 2 can be viewed as one particular implementation of the system 100 of FIG. 1.

Seen from the access side the 5G network architecture shown in FIG. 2 comprises a plurality of UEs 140 connected to either a RAN 120 or an Access Network (AN) as well as an Access and Mobility Management Function (AMF) 200. Typically, the R(AN) 120 comprises base stations, e.g. such as eNBs or gNBs or similar. Seen from the core network side, the 5G core NFs shown in FIG. 2 include a Network Slice Selection Function (NSSF) 202, an Authentication Server Function (AUSF) 204, a Unified Data Management (UDM) 206, the AMF 200, a Session Management Function (SMF) 208, a Policy Control Function (PCF) 210, and an Application Function (AF) 212.

Reference point representations of the 5G network architecture are used to develop detailed call flows in the normative standardization. The N1 reference point is defined to carry signaling between the UE 140 and AMF 200. The reference points for connecting between the AN 120 and AMF 200 and between the AN 120 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214, and N14 is the reference point connecting between different AMFs 200, respectively. N15 and N7 are defined since the PCF 210 applies policy to the AMF 200 and SMF 208, respectively. N12 is required for the AMF 200 to perform authentication of the UE 140. N8 and N10 are defined because the subscription data of the UE 140 is required for the AMF 200 and SMF 208.

The 5GC network aims at separating user plane and control plane. The user plane carries user traffic while the control plane carries signaling in the network. In FIG. 2, the UPF 214 is in the user plane and all other NFs, i.e., the AMF 200, SMF 208, PCF 210, AF 212, NSSF 202, AUSF 204, and UDM 206, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 200 and SMF 208 are independent functions in the control plane. Separated AMF 200 and SMF 208 allow independent evolution and scaling. Other control plane functions like the PCF 210 and AUSF 204 can be separated as shown in FIG. 2. Modularized function design enables the 5GC network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs.

FIG. 3 illustrates a 5G network architecture using service-based interfaces between the NFs in the control plane, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g. Namf for the service based interface of the AMF and Nsmf for the service based interface of the SMF etc. The Network Exposure Function (NEF) and the Network Function Repository Function (NRF) in FIG. 3 are not shown in FIG. 2 discussed above. However, it should be clarified that all NFs depicted in FIG. 2 can interact with the NEF and the NRF of FIG. 3 as necessary, though not explicitly indicated in FIG. 2.

Some properties of the NFs shown in FIGS. 2-3 may be described in the following manner. The AMF provides UE-based authentication, authorization, mobility management, etc. A UE even using multiple access technologies is basically connected to a single AMF because the AMF is independent of the access technologies. The SMF is responsible for session management and allocates IP addresses to UEs. It also selects and controls the UPF for data transfer. If a UE has multiple sessions, different SMFs may be allocated to each session to manage them individually and possibly provide different functionalities per session. The AF provides information on the packet flow to PCF responsible for policy control in order to support Quality of Service (QoS). Based on the information, PCF determines policies about mobility and session management to make AMF and SMF operate properly. The AUSF supports authentication function for UEs or similar and thus stores data for authentication of UEs or similar while UDM stores subscription data of UE. The Data Network (DN), not part of the 5G core network, provides Internet access or operator services and similar.

The Nudm_EventExposure service is used by consumer NFs (e.g. NEF) to subscribe to notifications of event occurrence by means of the Subscribe service operation. For events that can be detected by the AMF, the UDM makes use of the appropriate AMF service operation to subscribe on behalf of the consumer NF (e.g. NEF).

FIG. 4 illustrates a scenario 400 of an inter-AMF mobility procedure, where each time UE moves from an AMF to be served by another AMF will trigger an AOI report.

The scenario 400 shown in FIG. 4 involves AMF-1 401, AMF-2 403, NRF 405, NEF 407 and AF 409. It is only an example and the real scenario is not limited thereto.

At step S410, AF409 subscribes to be notified of a Monitoring event of type AOI, for UE-X. That is, if the AOI status changes, i.e., UE-X enters or leaves the indicated AOI, the AF 409 requests to be notified.

At step S420, NEF 407 obtains one or multiple Tracking Area Identities, TAIs, as a translation of the received geographical area that identifies the expected AOI.

At steps S430˜S450, NEF 407 needs to identify the AMF(s) that serve the TAIs in the TAI list, that is, that serve the expected AOI. For that, NEF 407 performs an NRF Discovery using the TAI as input. Note that a Discovery request with only one TAI in the list is required, in order for the NRF to provide any AMF serving this TAI (regardless of the AMF serving other TAIs in the List as well).

At step S460, NEF 407 subscribes to the AMF where the UE-X is located for the event, indicating the corresponding TAIs for the AOI (obtained in previous step). In this case, it is assumed that UE-X is served by AMF-1 401.

At step S470, AMF-1 401 determines that UE-X is not located in any of the AOI TAIs. Then at step S480, AMF-1 401 returns the current status (since immediate report was requested in step S460, status=OUT) to NEF 407.

At step S490, as an example, UE-X enters one of the TAIs in AOI, and it is still served by AMF-1 401. Since the AOI status has changed (UE-X has entered AOI), AMF-1 401 notifies NEF 407 of the UE entering the AOI (status=IN) at step S4100.

At step S4110, as an example, UE-X moves to a TAI served by AMF-2 403. AMF-2 403 requests AMF-1 401 for UE context. The UE context includes the ongoing events (including AOI event). AMF-1 401 returns the UE context to AMF-2 403. AMF-2 403 checks the status of UE-X, and notifies NEF 407 of the status of UE-X (AOI=IN) since UE-X is in a TAI belonging to AOI.

NEF 407 receives the incorrect information that UE-X has just entered the AOI, but NEF 407 already knows that. If NEF 407 returns the received information to AF 409, then AF 409 will also receive the incorrect information.

Moreover, in step S410 a number of reports to be received by AF 409 may be indicated. In this case, the remaining number of reports to be sent to AF 409 is decremented wrongly.

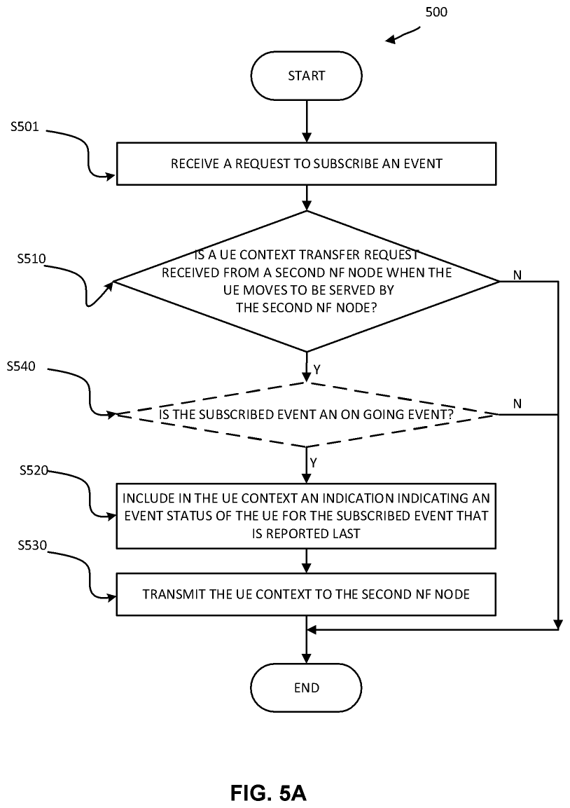

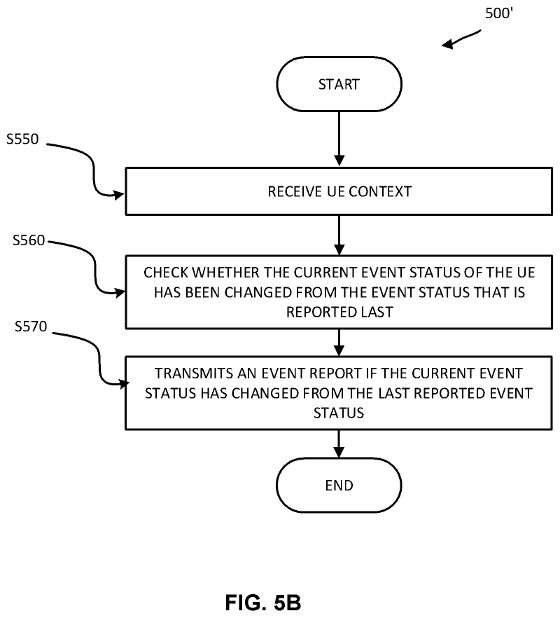

Hereinafter, a method for event report management in a network according to an exemplary embodiment of the present disclosure will be described with reference to FIGS. 5A-8.

FIG. 5A illustratively shows a flowchart of a method 500 for managing an event report for a UE according to an exemplary embodiment of the present disclosure. In an embodiment, the method 500 may be performed at a first NF node which serves the UE. The first NF node may be, for example, an AMF node.

As shown in FIG. 5A, the method 500 may include steps S501˜S540.

The method 500 may start in step S510, where the first NF node receives from a second NF node a UE context transfer request when the UE moves to be served by the second NF node. That is, initially the UE is served by the first NF node. Then the UE moves and becomes to be served by the second NF node. The second NF node sends a UE context transfer request to the first NF node for requesting UE context.

Then the method proceeds to step S520, in which the first NF node includes an indication indicating an event status of the UE for a first subscribed event that is reported last in the first UE context. And in step S530, the first NF node transmits the first UE context to the second NF node.

In the exemplary embodiment of the present disclosure, the first NF node, i.e., a source NF node of the inter-AMF mobility procedure, transmits an indication indicating the last reported event status of the UE for a subscribed event to the second NF node, i.e., a target NF node of the inter-AMF mobility procedure, by for example including the indication in the UE context. Accordingly, the second NF node, when receiving the UE context including a subscribed event, may decide not to report the current event status of the subscribed event if it determines that the current event status has not changed from the event status that is reported last.

In an exemplary embodiment of the present disclosure, the method 500 may further comprise step S540 in which the first NF node checks whether the first subscribed event is an ongoing event, and includes the indication in the first UE context if the first subscribed event is an ongoing event in step S520. The target NF node shall report the current status of the UE for a subscribed event which is ongoing upon receiving the UE context. Accordingly, the first NF node may only include the indication for an ongoing event in the first UE context.

In an exemplary embodiment of the present disclosure, each of the first NF node and the second NF node mentioned in the method 500 may be an AMF node during the inter-AMF mobility procedure. That is, the first NF node may be a source AMF with respect to the second NF node and the second NF node may be a target AMF during the inter-AMF mobility procedure.

In an exemplary embodiment of the present disclosure, the method 500 may further comprise step S501 of receiving from a fourth NF node a request to subscribe to the event for the UE prior to receiving UE context transfer request. That is, the first NF node has received a subscription for an event status for the UE, and then the first NF node shall include the indication for the event in the UE context and transmit to the second NF node during the subsequent inter-AMF mobility procedure.

The fourth NF node is a NF service consumer for the event, e.g., one of SMF, PCF, NEF, UDM, and AF depending on the event.

In an exemplary embodiment of the present disclosure, the subscribed event is an AOI event.

In an exemplary embodiment of the present disclosure, the Report Type for the first subscribed event is Continuously Report. As specified in 3GPP TS 29.518 5.3.1, the Report Type for the AOI event may be One-Time Report or Continuously Report. For a One-Time Report event, the first NF node may had already reported the status of the UE upon receiving the subscription for the event, and the second NF node does not need to report the status of the UE upon receiving the UE context during the inter-AMF mobility procedure. Accordingly, there may be no need for the first NF node to include the indication in the context for a subscribed event having a Report Type of One-Time Report. Contrarily, for a subscribed event having a Report Type of Continuously report, the second NF node shall report the status of the UE upon receiving the UE context during the inter-AMF mobility procedure, and thus the first NF node shall include the indication in the UE context and transmit to the second NF node.

In an exemplary embodiment of the present disclosure, the event is subscribed per UE, or per group of UEs. That is, no matter the event is subscribed per UE or per group of UEs, the method 500 is applicable.

In an exemplary embodiment of the present disclosure, the event report indicates the presence status of the UE in the AOI, including IN/OUT/UNKNOWN. For the cases where the first subscribed event is an AOI event, the event report indicates the presence status of the UE in the AOI. The presence status may be one of IN, OUT, and UNKNOWN.

FIG. 5B illustratively shows a flowchart of a method 500′ for managing an event report for a UE according to an exemplary embodiment of the present disclosure. In an embodiment, the method 500′ may be performed at a first NF node which serves the UE. The first NF node may be, for example, an AMF node.

As shown in FIG. 5B, the method 500′ may include steps S550˜S570.

In some cases the first NF node may also be a target NF node of the inter-AMF mobility procedure which receives UE context from another NF node. In such cases, the method 500′ may comprise step S550 in which it receives second UE context from a third NF node, i.e., a source NF node of the inter-AMF mobility procedure. The UE context includes an indication indicating an event status of the UE for a second subscribed event that is reported last.

In response to receiving the UE context, the first NF node determines whether the current event status of the UE of the second subscribed event has changed from the event status that is reported last by checking the indication in the second UE context in step S560.

In an exemplary embodiment of the present disclosure, the method 500′ may further comprise step S570 in which the first NF node transmits an event report indicating the current event status of the UE of the second subscribed event only if it is determined that the current event status of the UE of the second subscribed event has changed from the event status that is reported last.

In an exemplary embodiment of the present disclosure, the second subscribed event is an AOI event. For an AOI event, the serving NF node shall provide the current event status of the UE when receiving the UE context. According to the present disclosure, the serving NF node, when receiving the UE context (that is, the serving NF node is the target NF node of inter-AMF mobility procedure), may check whether the current status of the UE has changed from the status that is reported last, and report the current status of the UE only if the status has changed.

In an exemplary embodiment of the present disclosure, each of the first NF node and the third NF node mentioned in the method 500′ may be an AMF node during the inter-AMF mobility procedure. That is, the third NF node may by a source AMF, and the first NF node may be a target AMF with respect to the third NF node.

In the exemplary embodiment of the present disclosure, the first NF node (for example a source AMF of the inter-AMF mobility procedure), which supports an event notification to a subscribed NF node, provides an indication indicating the last report event status of the UE for the subscribed event to a second NF node (for example a target AMF of the inter-AMF mobility procedure) along with the subscription of the subscribed event in for example, the UE context, so that the second NF node may decide whether to report the current status of the subscribed event by checking the indication. For example, the second NF node, when receiving the UE context including a subscribed event, may decide not to report the current event status of the subscribed event if it determines that the current event status has not changed from the event status that is reported last. Accordingly, a redundant report that has been transmitted to the subscribed NF node may be avoided, and the remaining number of reports will not be decremented wrongly.

The terms “first” and “second” used in “first UE context” and “second UE context” are to distinguish the UE context transmitted from the first NF node and the UE context received by the first NF node without any substantial limitation on the meaning of “UE context.” Similarly, terms “first” and “second” used in “first subscribed event” and “second subscribed event” are to distinguish the subscribed event transmitted along with the first UE context and the subscribed event transmitted along with the second UE context without any substantial limitation on the meaning of “subscribed event.”

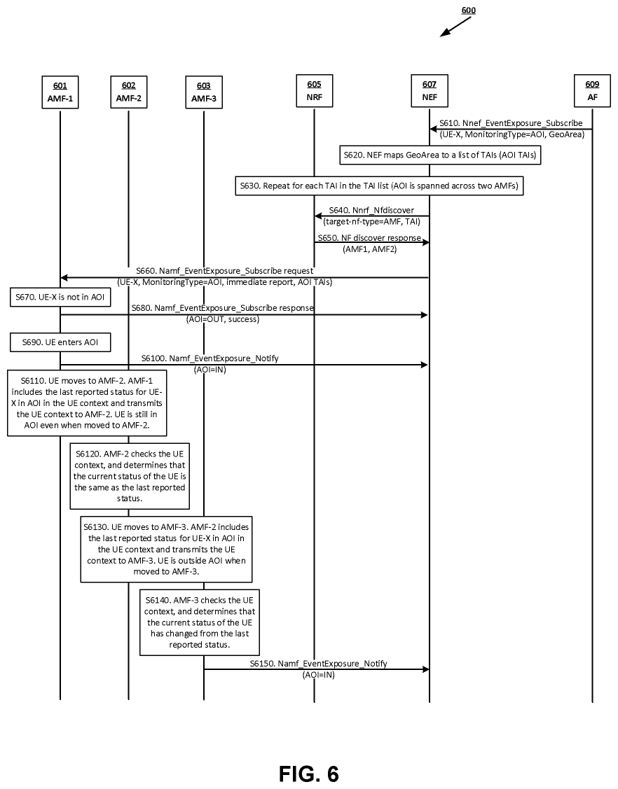

FIG. 6 shows an exemplifying signaling diagram illustrating a scenario 600 where the indication of the present disclosure is applied.

The scenario 600 shown in FIG. 6 involves AMF-1 601, AMF-2 602, AMF-3 603, NRF 605, NEF 607 and AF 609. It is only an example and the real scenario is not limited thereto.

Steps S610˜S6100 are the same as step S410˜S4100 described with respect to FIG. 4. In particular, at step S610, AF609 subscribes to be notified of a Monitoring event of type AOI, for UE-X. That is, if the AOI status changes, i.e., UE-X enters or leaves the indicated AOI, the AF 609 requests to be notified. At step S620, NEF 607 obtains one or multiple TAIs as a translation of the received geographical area that identifies the expected AOI. At steps S630˜S650, NEF 607 needs to identify the AMF(s) that serve the TAIs in the TAI list, that is, that serve the expected AOI. For that, NEF 607 performs an NRF Discovery using the TAI as input. Note that a Discovery request with only one TAI in the list is required, in order for the NRF to provide any AMF serving this TAI (regardless of the AMF serving other TAIs in the List as well). At step S660, NEF 607 subscribes to AMF-1 601 for the event, indicating the corresponding TAIs for the AOI (obtained in previous step). At step S670, AMF-1 601 determines that UE-X is not located in any of the AOI TAIs. Then at step S680, AMF-1 601 returns the current status (since immediate report was requested in step S660, status=OUT) to NEF 607. At step S690, as an example, UE-X enters one of the TAIs in AOI, and it is still served by AMF-1 601. Since the AOI status has changed (UE-X has entered AOI), AMF-1 601 notifies NEF 607 of the UE entering the AOI (status=IN) at step S6100. Step S660 is an example of step S501 as shown in FIG. 5A.

At step S6110, as an example, UE-X moves to a TAI served by AMF-2 602. AMF-2 602 requests AMF-1 601 for UE context. The UE context includes the ongoing events (including AOI event). AMF-1 601 includes an indication of the last reported status for UE-X in AOI in the UE context and transmits the UE context to AMF-2 602. Step S6110 is an example of step S520 and step S530 as shown in FIG. 5A.

At step S6120, AMF-2 602 checks the status of UE-X, and additionally checks the last reported status for UE-X in the UE context. In this case, AMF-2 602 determines that UE-X is still in AOI (AOI=IN), the same status as the last reported status, and does not notify NEF 407 of the status of UE-X. Step S6120 is an example of step S560 as shown in FIG. 5B.

At step S6130, as an example, UE-X moves to a TAI served by AMF-3 603. AMF-3 603 request AMF-2 602 for UE context. The UE context includes the ongoing events (including AOI event). AMF-2 602 includes an indication of the last reported status for UE-X in AOI in the UE context and transmits the UE context to AMF-3 603. In this case, AMF-2 602 does not report the status for UE-X, and thus the last reported status for UE-X is that reported by AMF-1 601 in step S6100 and transmitted to AMF-2 602 at step S6110. Step S6130 is an example of step S550 as shown in FIG. 5B.

At step S6140, AMF-3 603 checks the status of UE-X, and additionally checks the last reported status for UE-X in the UE context. In this case, AMF-3 603 determines that the status of UE-X has changed from the last reported status (IN->OUT). Then at step S6150, AMF-3 603 notifies NEF 607 of the status of UE-X (AOI=OUT) since UE-X leaves the OAI. NEF 407 returns the received information to AF 409. Step S6140 is an example of step S560 as shown in FIG. 5B, and step S6150 is an example of step S570 as shown in FIG. 5B.

In the exemplifying signaling diagram, NEF 407 would not be notified with incorrect information since AMF-2 602 that receives the UE context may decide not to notify NEF with the current status related to the subscription of mobility event if AMF-2 602 determines that the status has not changed from the last reported status. If a number of reports to be received by AF 409 are indicated, the remaining number of reports to be sent to AF 409 can be decremented correctly.

The flowchart shown in FIG. 6 is only an example of the scenario where the indication of the present disclosure is applied. The NF service consumers shown in FIG. 6 comprise NEF 607 and AP 609. It is known that there may be different NF services, and the NF service consumers may also be different, resulting in different flowcharts. For example, the services offered by the AMF comprise Namf_EventExposure Service, and the known Service Consumers are NEF, SMF, UDM, NWDAF, DCCF, LMF, and GMLC. Depending on the service, the flowchart for subscribing the service may be different. Accordingly, the steps S610˜S660 as shown in FIG. 6 may be various for different services.

The following section contains a copy of the suggested change in the 3GPP TS 29.518 V17.6.0. This also describes examples of the suggested invention. Added text is underlined and deleted text is striked through.

### 6.1.6.2.66 Type: AmfEventSubscriptionAddInfo

TABLE 6.1.6.2.66-1
Definition of type AmfEventSubscriptionAddInfo

| Attribute name | Data type | P | Cardinality | Description |
|---|---|---|---|---|
| bindingInfo | array(string) | O | 1 . . . 2 | Binding indications received for event |
| | | | | notifications (i.e. with “callback” scope) or |
| | | | | for subscription change event |
| | | | | notifications (i.e. with |
| | | | | “subscription-events” scope) for an AMF |
| | | | | event subscription. |
| | | | | When present, entries of the array shall |
| | | | | be set to the value of the |
| | | | | 3gpp-Sbi-Binding header defined in |
| | | | | clause 5.2.3.2.6 of 3GPP TS 29.500 [4], |
| | | | | without the header name. |
| | | | | Example of an array entry: “bl= nf-set; |
| | | | | nfset=set1.udmset.5gc.mnc012.mcc345; |
| | | | | servname=nudm-ee;scope=subscription- |
| | | | | events” |
| subscribingNfType | NFType | C | 0 . . . 1 | This IE should be present if the |
| | | | | information is available. When present, it |
| | | | | shall contain the NF type of the NF that |
| | | | | created the subscription. |
| | | | | (NOTE 1) |
| eventSyncInd | boolean | C | 0 . . . 1 | This IE should be present with value |
| | | | | “true” when the event subscription shall |
| | | | | be synchronized with UDM during EPS to |
| | | | | 5GS mobility registration procedure, as |
| | | | | specified in clause 5.3.2.4.2. |
| | | | | When present, this IE shall be set as |
| | | | | following: |
| | | | | true: the event subscription shall be |
| | | | | synchronized with UDM. |
| | | | | false: the event subscription shall not be |
| | | | | synchronized with UDM. |
| aoiStateOldAmf | map | C | 1 . . . N | Map of subscribed Area of Interest (AoI) |
| | (AreaOfInterestEventState) | | | Event State in the old AMF, the JSON |
| | | | | pointer to an AmfEventArea in areaList IE |
| | | | | or a PresenceInfo in presenceInfoList IE |
| | | | | in the subscribed AoI Event(s) shall be |
| | | | | the key of the map. |
| | | | | (NOTE x) |

NOTE 1:
In scenarios where an “intermediate NF” (e.g. UDM) creates a subscription on behalf of a “source NF” (e.g. NEF), this IE shall contain the NF type of the “intermediate NF”. The NF type of the “source NF” may be available in the AmfEventSubscription.
NOTE x:
The new AMF may use the information to determine whether the UE presence state in the AOI(s) has changed, thus should be reported to the NF consumer.

### 6.1.6.2.xx Type: AreaOfInterestEventState

TABLE 6.1.6.2.xx-1
Definition of type AreaOfInterestEventState

| Attribute name | Data type | P | Cardinality | Description |
|---|---|---|---|---|
| presence | PresenceState | M | 1 | This IE shall indicate the UE presence in |
| | | | | the indicated area of interest. |
| individualPra | string | C | 0 . . . 1 | This IE may be present if the indicated |
| | | | | area of interest referring to a set of Core |
| | | | | Network predefined Presence Reporting |
| | | | | Areas and the UE is in an individual PRA |
| | | | | within the set of Core Network |
| | | | | predefined Presence Reporting Areas. |
| | | | | When present, this IE shall contain the |
| | | | | PRA Identifier of the individual PRA |
| | | | | where the UE is located. |

The above is merely an example implementation of the suggest invention. For example, the terminology for “aoiStateOldAmf” may be different for the real implementation. As an alternative, the modification may be made to “Presence Status” by adding an IE to indicate the last reported status. The suggest invention may also be implemented by other modifications of the specification.

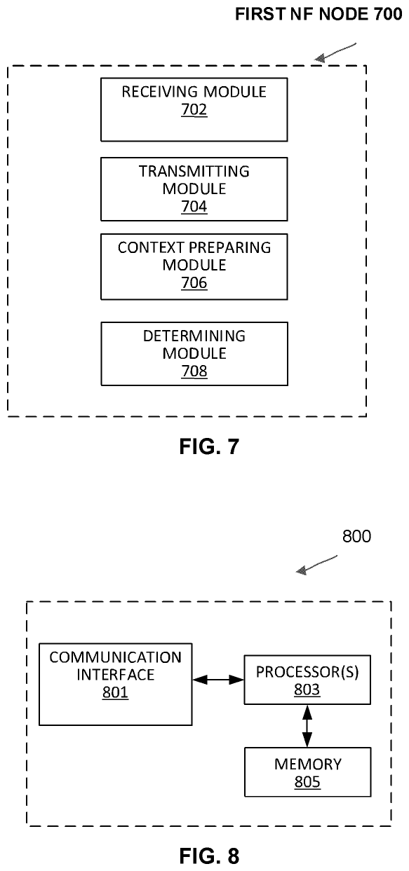

Hereinafter, a structure of a first NF node will be described with reference to FIG. 7. FIG. 7 illustratively shows a schematic structure diagram of a first NF node 700 (e.g. first NF node as mentioned in FIGS. 5A and 5B and AMF-1˜AMF-3 as shown in FIG. 6, as described previously) according to an exemplary embodiment of the present disclosure. The first NF node 700 in FIG. 7 may perform the method 500 for managing an event report for a UE described previously with reference to FIG. 5A and the method 500′ for managing an event report for a UE described previously with reference to FIG. 5B. Accordingly, some detailed description on the first NF node 700 may refer to the corresponding description of the method 500 and method 500′.

As shown in FIG. 7, the first NF node 700 may include a receiving module 702, a transmitting module 704, a context preparing module 706 and a determining module 708. As will be understood by the skilled in the art, common components in the first NF node 700 are omitted in FIG. 7 for not obscuring the idea of the present disclosure. Also, some modules may be distributed in more modules or integrated into fewer modules. For example, the receiving module 702 and the transmitting module 704 may be integrated into a transceiver module.

The first NF node 700 is included in a first NF node set comprising a number of first NF nodes.

In an exemplary embodiment of the present disclosure, the receiving module 702 of the first NF node 700 may be configured to receive from a fourth NF node (i.e., a NF service consumer) a request to subscribe to an event for a UE served by the first NF node 700.

In an exemplary embodiment of the present disclosure, the receiving module 702 of the first NF node 700 may be configured to receive from a second NF node a UE context transfer request when the UE moves to be served by the second NF. The context preparing module 706 of the first NF node 700 may be configured to prepare first UE context by including an indication indicating an event status of the UE for a first subscribed event that is reported last in the UE context. And the transmitting module 704 of the first NF node 700 may be configured to transmit the first prepared UE context to the second NF node.

In the exemplary embodiment of the present disclosure, the first NF node 700, i.e., a source NF node of the inter-AMF mobility procedure, transmits an indication indicating the last reported event status of the UE for a subscribed event to the second NF node, i.e., a target NF node of the inter-AMF mobility procedure, by for example including the indication in the UE context. Accordingly, the second NF node, when receiving the UE context including a subscribed event, may decide not to report the current event status of the subscribed event if it determines that the current event status has not changed from the event status that is reported last.

In an exemplary embodiment of the present disclosure, the determining module 708 of the first NF node 700 may be configured to determine whether the first subscribed event is an ongoing event, and the context preparing module 706 of the first NF node 700 may be configured to include the indication in the first UE context if the determining module 708 determines that the first subscribed event is an ongoing event.

In an exemplary embodiment of the present disclosure, the first subscribed event is an AOI event.

In an exemplary embodiment of the present disclosure, the Report Type for the first subscribed event is Continuously Report. As specified in 3GPP TS 29.518 5.3.1, the Report Type for the AOI event may be One-Time Report or Continuously Report. For a One-Time Report event, the first NF node 700 may had already reported the status of the UE upon receiving the subscription for the event, and the second NF node does not need to report the status of the UE upon receiving the UE context during the inter-AMF mobility procedure. Accordingly, there may be no need for the first NF node 700 to include the indication in the context for a subscribed event having a Report Type of One-Time Report. Contrarily, for a subscribed event having a Report Type of Continuously report, the second NF node shall report the status of the UE upon receiving the UE context during the inter-AMF mobility procedure, and thus the first NF node 700 shall include the indication in the UE context and transmit to the second NF node.

In an exemplary embodiment of the present disclosure, the event report indicates the presence status of the UE in the AOI, including IN/OUT/UNKNOWN. For the cases where the first subscribed event is an AOI event, the event report indicates the presence status of the UE in the AOI. The presence status may be one of IN, OUT, and UNKNOWN.

In an exemplary embodiment of the present disclosure, the receiving module 702 of the first NF node 700 may be configured to receive second UE context from a third NF node. The second UE context includes an indication indicating an event status of the UE for a second subscribed event that is reported last.

In response to receiving the UE context, the determining module 708 of the first NF node 700 may be configured to determine whether the current event status of the UE of the second subscribed event has changed from the event status that is reported last by checking the indication in the second UE context.

In an exemplary embodiment of the present disclosure, the transmitting module 704 of the first NF node 700 may be configured to transmit an event report indicating the current event status of the UE of the second subscribed event only if it is determined by the determining module 708 that the current event status of the UE of the second subscribed event has changed from the event status that is reported last.

In an exemplary embodiment of the present disclosure, the second subscribed event is an AOI event. For an AOI event, the serving NF node shall provide the current event status of the UE when receiving the UE context. According to the present disclosure, the first NF node 700, which becomes a serving NF node, when receiving the UE context (that is, the serving NF node is the target NF node of inter-AMF mobility procedure), may check whether the current status of the UE has changed from the status that is reported last, and report the current status of the UE only if the status has changed.

In the exemplary embodiment of the present disclosure, the first NF node 700 (for example a source AMF of the inter-AMF mobility procedure), which supports an event notification to a subscribed NF node, provides an indication indicating the last report event status of the UE for the subscribed event to a second NF node (for example a target AMF of the inter-AMF mobility procedure), so that the second NF node may decide whether to report the current status of the subscribed event by checking the indication. For example, the second NF node, when receiving the UE context including a subscribed event, may decide not to report the current event status of the subscribed event if it determines that the current event status has not changed from the event status that is reported last. Accordingly, a redundant report that has been transmitted to the subscribed NF node may be avoided, and the remaining number of reports will not be decremented wrongly.

Hereinafter, another structure of a first NF node 800 will be described with reference to FIG. 8. FIG. 8 illustratively shows a schematic structure diagram of a first NF node 800 (e.g., first NF node as mentioned in FIGS. 5A and 5B and AMF-1˜AMF-3 as shown in FIG. 6, as described previously) according to an exemplary embodiment of the present disclosure. The first NF node 800 in FIG. 8 may perform the method 500 for managing an event report for a UE described previously with reference to FIG. 5A and the method 500′ for managing an event report for a UE described previously with reference to FIG. 5B. Accordingly, some detailed description on the first NF node 800 may refer to the corresponding description of the method 500 and method 500′.

As shown in FIG. 8, the first NF node 800 may include at least one controller or processor 803 including e.g., any suitable Central Processing Unit, CPU, microcontroller, Digital Signal Processor, DSP, etc., capable of executing computer program instructions. The computer program instructions may be stored in a memory 805. The memory 805 may be any combination of a RAM (Random Access Memory) and a ROM (Read Only Memory). The memory may also comprise persistent storage, which, for example, can be any single one or combination of magnetic memory, optical memory, or solid state memory or even remotely mounted memory. The exemplary first NF node 800 further comprises a communication interface 801 arranged for communication.

The instructions, when loaded from the memory 805 and executed by the at least one processor 803, may cause the first NF node 800 to perform the method 500 for managing an event report for a UE described previously with reference to FIG. 5A and the method 500′ for managing an event report for a UE described previously with reference to FIG. 5B. The first NF node 800 is included in a first NF node set comprising a number of first NF nodes.

In particular, in an exemplary embodiment of the present disclosure, the instructions, when loaded from the memory 805 and executed by the at least one processor 803, may cause the first NF node 800 to receive via the communication interface 801 from a fourth NF node (i.e., a NF service consumer) a request to subscribe to an event for a UE served by the first NF node 800.

In an exemplary embodiment of the present disclosure, the instructions, when loaded from the memory 805 and executed by the at least one processor 803, may cause the first NF node 800 to receive via the communication interface 801 from a second NF node a UE context transfer request when the UE moves to be served by the second NF, prepare first UE context by including an indication indicating an event status of the UE for a first subscribed event that is reported last in the first UE context, and transmit the first prepared UE context to the second NF node.

In the exemplary embodiment of the present disclosure, the first NF node 800, i.e., a source NF node of the inter-AMF mobility procedure, transmits an indication indicating the last reported event status of the UE for a subscribed event to the second NF node, i.e., a target NF node of the inter-AMF mobility procedure, by for example including the indication in the UE context. Accordingly, the second NF node, when receiving the UE context including a subscribed event, may decide not to report the current event status of the subscribed event if it determines that the current event status has not changed from the event status that is reported last.

In an exemplary embodiment of the present disclosure, the instructions, when loaded from the memory 805 and executed by the at least one processor 803, may cause the first NF node 800 to determine whether the first subscribed event is an ongoing event, and include the indication in the UE context if it determines that the first subscribed event is an ongoing event.

In an exemplary embodiment of the present disclosure, the first subscribed event is an AOI event.

In an exemplary embodiment of the present disclosure, the Report Type for the first subscribed event is Continuously Report. As specified in 3GPP TS 29.518 5.3.1, the Report Type for the AOI event may be One-Time Report or Continuously Report. For a One-Time Report event, the first NF node 800 may had already reported the status of the UE upon receiving the subscription for the event, and the second NF node does not need to report the status of the UE upon receiving the UE context during the inter-AMF mobility procedure. Accordingly, there may be no need for the first NF node 800 to include the indication in the context for a subscribed event having a Report Type of One-Time Report. Contrarily, for a subscribed event having a Report Type of Continuously report, the second NF node shall report the status of the UE upon receiving the UE context during the inter-AMF mobility procedure, and thus the first NF node 800 shall include the indication in the UE context and transmit to the second NF node.

In an exemplary embodiment of the present disclosure, the event report indicates the presence status of the UE in the AOI, including IN/OUT/UNKNOWN. For the cases where the first subscribed event is an AOI event, the event report indicates the presence status of the UE in the AOI. The presence status may be one of IN, OUT, and UNKNOWN.

In an exemplary embodiment of the present disclosure, the instructions, when loaded from the memory 805 and executed by the at least one processor 803, may cause the first NF node 800 to receive second UE context from a third NF node via the communication interface 801. The second UE context includes an indication indicating an event status of the UE for a second subscribed event that is reported last.

In an exemplary embodiment of the present disclosure, the instructions, when loaded from the memory 805 and executed by the at least one processor 803, may cause the first NF node 800 to determine whether the current event status of the UE of the second subscribed event has changed from the event status that is reported last by checking the indication in the second UE context.

In an exemplary embodiment of the present disclosure, the instructions, when loaded from the memory 805 and executed by the at least one processor 803, may cause the first NF node 800 to transmit, via the communication interface 801, an event report indicating the current event status of the UE of the second subscribed event only if it is determined that the current event status of the UE of the second subscribed event has changed from the event status that is reported last.

In an exemplary embodiment of the present disclosure, the second subscribed event is an AOI event. For an AOI event, the serving NF node shall provide the current event status of the UE when receiving the UE context. According to the present disclosure, the first NF node 800, which becomes a serving NF node, when receiving the UE context (that is, the serving NF node is the target NF node of inter-AMF mobility procedure), may check whether the current status of the UE has changed from the status that is reported last, and report the current status of the UE only if the status has changed.

In the exemplary embodiment of the present disclosure, the first NF node 800 (for example a source AMF of the inter-AMF mobility procedure), which supports an event notification to a subscribed NF node, provides an indication indicating the last report event status of the UE for the subscribed event to a second NF node (for example a target AMF of the inter-AMF mobility procedure), so that the second NF node may decide whether to report the current status of the subscribed event by checking the indication. For example, the second NF node, when receiving the UE context including a subscribed event, may decide not to report the current event status of the subscribed event if it determines that the current event status has not changed from the event status that is reported last. Accordingly, a redundant report that has been transmitted to the subscribed NF node may be avoided, and the remaining number of reports will not be decremented wrongly.

Aspects of the disclosure may also be embodied as methods and/or computer program products. Accordingly, the disclosure may be embodied in hardware and/or in hardware/software (including firmware, resident software, microcode, etc.). Furthermore, the embodiments may take the form of a computer program product on a computer-usable or computer-readable storage medium having computer-usable or computer-readable program code embodied in the medium for use by or in connection with an instruction execution system. Such instruction execution system may be implemented in a standalone or distributed manner. The actual software code or specialized control hardware used to implement embodiments described herein is not limiting of the disclosure. Thus, the operation and behavior of the aspects were described without reference to the specific software code, it being understood that those skilled in the art will be able to design software and control hardware to implement the aspects based on the description herein.

Furthermore, certain portions of the disclosure may be implemented as “logic” that performs one or more functions. This logic may include hardware, such as an application specific integrated circuit or field programmable gate array or a combination of hardware and software.

It should be emphasized that the term “comprises/comprising” when used in this specification is taken to specify the presence of stated features, integers, steps, components or groups but does not preclude the presence or addition of one or more other features, integers, steps, components or groups thereof.

No element, act, or instruction used in the disclosure should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

The foregoing description gives only the embodiments of the present disclosure and is not intended to limit the present disclosure in any way. Thus, any modification, substitution, improvement or like made within the spirit and principle of the present disclosure should be encompassed by the scope of the present disclosure.

1. A method implemented at a first Network Function, NF, node for managing an event report for a user equipment, UE, that is served by the first NF node, the method comprising:
in response to receiving, from a second NF node, a UE context transfer request when the UE moves to be served by the second NF node, including in first UE context an indication indicating an event status of the UE for a first subscribed event that is reported last; and
transmitting the first UE context to the second NF node.

2. The method of claim 1, further comprising:
in response to receiving second UE context from a third NF node, the second UE context including an indication indicating an event status of the UE for a second subscribed event that is reported last, determining whether the current event status of the UE of the second subscribed event has changed from the event status that is reported last by checking the indication in the second UE context.

3. The method of claim 2, further comprising:
transmitting an event report indicating the current event status of the UE of the second subscribed event only if it is determined that the current event status of the UE of the second subscribed event has changed from the event status that is reported last.

4. The method of claim 3, wherein each of the first and second subscribed events is an Area Of Interest, AOI, event.

5. The method of claim 1, further comprising checking whether the first subscribed event is an ongoing event; and
including an indication in the first UE context comprises including the indication in the first UE context if the first subscribed event is an ongoing event.

6. The method of claim 1, wherein each of the first NF node, the second NF node and the third NF node is an Access and Mobility Management Function, AMF, node.

7. The method of claim 1, wherein prior to receiving a UE context transfer request, the method further comprises:
receiving a request from a fourth NF node to subscribe to the event for the UE.

8. The method of claim 4, wherein a Report Type for the first and second subscribed events is Continuously Report.

9. The method of claim 4, wherein each of the first and second subscribed events is subscribed per UE, or per group of UEs.

10. The method of claim 4, wherein the event report indicates the presence status of the UE in the AOI, including IN/OUT/UNKNOWN.

11. A first Network Function, NF, node for managing an event report for a user equipment, UE, that is served by the first NF node, the first NF node comprising:
a communication interface arranged for communication;
at least one processor; and
a memory comprising instructions which, when executed by the at least one processor, cause the first NF node to:
in response to receiving, from a second NF node, a UE context transfer request when the UE moves to be served by the second NF node, include in first UE context an indication indicating an event status of the UE for a first subscribed event that is reported last; and
transmit the first UE context to the second NF node.

12. (canceled)

13. (canceled)

14. The method claim 1, wherein each of the first and second subscribed events is an Area Of Interest, AOI, event.

15. The first NF node of claim 11, wherein the first NF node is further caused to:
in response to receiving second UE context from a third NF node, the second UE context including an indication indicating an event status of the UE for a second subscribed event that is reported last, determine whether the current event status of the UE of the second subscribed event has changed from the event status that is reported last by checking the indication in the second UE context.

16. The first NF node of claim 15, wherein the first NF node is further caused to:
transmit an event report indicating the current event status of the UE of the second subscribed event only if it is determined that the current event status of the UE of the second subscribed event has changed from the event status that is reported last.

17. The first NF node of claim 16, wherein each of the first and second subscribed events is an Area Of Interest, AOI, event.

18. The first NF node of claim 17, wherein a Report Type for the first and second subscribed events is Continuously Report.

19. The first NF node of claim 17, wherein each of the first and second subscribed events is subscribed per UE, or per group of UEs.

20. The first NF node of claim 11, wherein the first NF node is further caused to:
check whether the first subscribed event is an ongoing event; and
include an indication in the first UE context comprises including the indication in the first UE context if the first subscribed event is an ongoing event.

21. The first NF node of claim 11, wherein each of the first NF node, the second NF node and the third NF node is an Access and Mobility Management Function, AMF, node.

22. The first NF node of claim 11, wherein the first NF node is further caused to:
prior to receiving a UE context transfer request, receive a request from a fourth NF node to subscribe to the event for the UE.
